(19) United States
(12) Patent Application Publication
(10) Pub. No.: US 2007/0068031 A1
(43) Pub. Date: Mar. 29, 2007

(54) Bathroom blow dryer

(76) Inventor: Julie M. Dascher, Independence, WI (US)

Correspondence Address: JULIE M. DASCHER, P.O. BOX 214, 23675 PUTNAM ST., INDEPENDENCE, WI, 54747, US

(21) Appl. No.: 11/079,501

(22) Filed: Sep. 26, 2005

(51) Int. Cl. F26B 19/00; F26B 25/06

(52) U.S. Cl. 34/233; 34/90

(57) ABSTRACT

An idea for a heating unit designed to keep your whole body warm after taking a shower or bath, plus dry you off without the use of a towel which will also save on the environment. I believe it will be usefull at: 1. HOME 2. Nursing Homes 3. Hospitals 4. Hotels 5. and Locker Rooms.

### FIELD OF THE INVENTION

The present invention relates to the hand dryers used in Public Restrooms to dry the hands.

### BRIEF DESCRIPTION OF THE DRAWINGS

With reference to the attached drawings this invention consists of:

FIG. 1. 3 fans

FIG. 2. ON/OFF Switch

FIG. 3. 3-Speed Fan Dial

FIG. 4. Heating Coils

FIG. 5. SAFETY Screen

FIG. 6. Unit is 14″ Wide

FIG. 7. Unit is 5′ In Length.

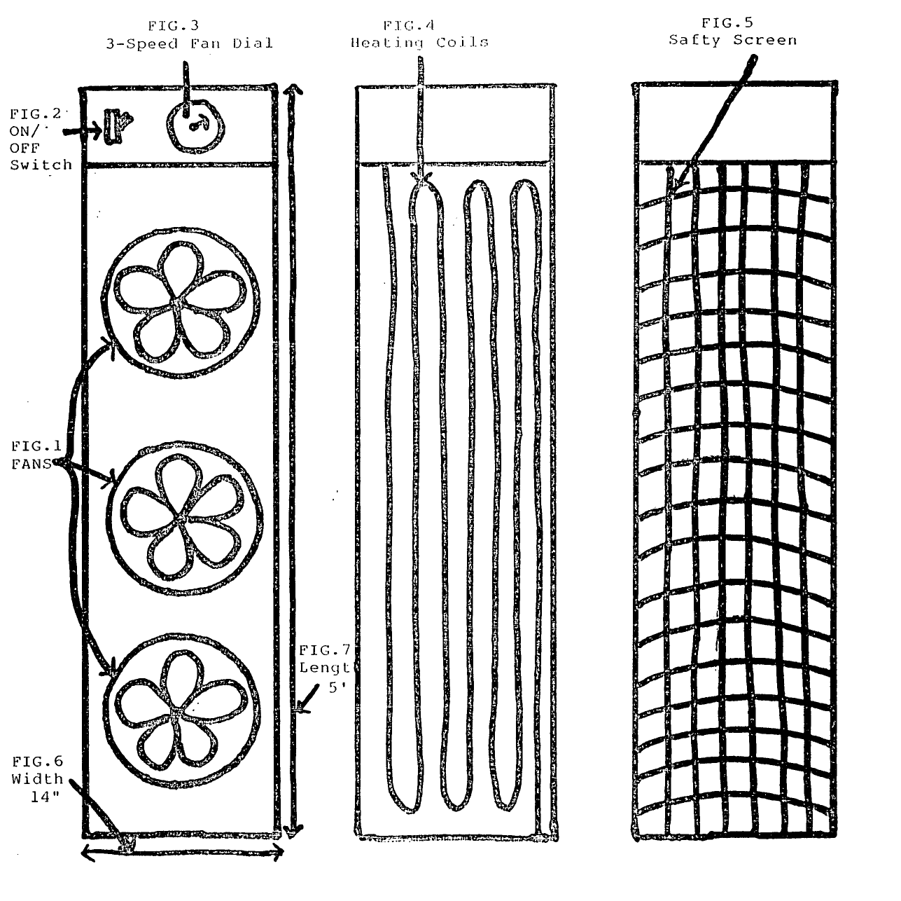

What I claim as my invention is:

1. The idea to construct a unit used in the bathroom to blow warm air to keep your whole body warm as well as dry your body without the use of a towel.
